(19) United States
(12) Patent Application Publication
(10) Pub. No.: US 2014/0349660 A1
(43) Pub. Date: Nov. 27, 2014

(54) RESOURCE SCHEDULING IN A MOBILE COMMUNICATION NETWORK SUPPORTING MACHINE-TO-MACHINE (M2M) AND USER EQUIPMENT (UE) TRAFFIC

(71) Applicant: TELEFONAKTIEBOLAGET L M ERICSSON (PUBL), (US)

(72) Inventor: Isam Abdalla, Irving, TX (US)

(73) Assignee: TELEFONAKTIEBOLAGET L M ERICSSON (PUBL), Stockholm (SE)

(21) Appl. No.: 13/900,709

(22) Filed: May 23, 2013

(51) Int. Cl. H04W 4/00; H04W 72/04

(52) U.S. Cl. CPC H04W 4/005; H04W 72/048
USPC 455/450

(57) ABSTRACT

A system and method that differentiates between Machine-to-Machine (M2M) traffic and User Equipment (UE) traffic when scheduling radio Resource Units (RUs) to M2M terminals and UEs in a Long Term Evolution (LTE) network. Prior to allocation of RUs, the available RUs are divided into two disjoint sets—a UE-specific set (dedicated for UE users) and an M2M-specific set (dedicated for M2M terminals). A hybrid scheduler allocates RUs to M2M terminals from the M2M-specific set only. Any unallocated RUs from the M2M-specific set and the RUs assigned to the UE-specific set are then allocated to the UEs. New M2M-specific Quality of Service Class Indicators (QCIs) are defined as well for classifying M2M traffic only. These new QCIs are disjoint from the existing QCIs, which classify the UE traffic only. The M2M-specific QCIs separate M2M traffic classification from UE traffic classification so as not to impact UE human users' Quality of Experience (QoE).

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present disclosure relates to Radio Resource Management (RRM) in a mobile communication network. More particularly, and not by way of limitation, particular embodiments of the present disclosure are directed to a system and method to differentiate between Machine-to-Machine (M2M) and User Equipment (UE) traffic in a mobile communication network and to utilize M2M-specific Quality of Service Class Identifier (QCI) values to schedule resources and facilitate end-to-end Quality of Service (QoS) for M2M traffic without impacting the Quality of Experience (QoE) of UE users.

### BACKGROUND

Machine-to-Machine (M2M) communications involve the communication (using wired or wireless means, or a combination of both) between two machines without human intervention. It is noted here that the term “M2M communication” is also referred to as “Machine Type Communication (MTC)” in certain literature. Hence, these terms may be used interchangeably in the discussion herein Some examples of M2M communications are: smart metering (e.g., remote reading of a utility meter), healthcare monitoring (e.g., remote monitoring of a patient's heart rate), agricultural monitoring (e.g., monitoring of a crop condition), forest supervision (e.g., monitoring of illegal poaching or logging), fleet management tracking (e.g., monitoring current status of trucks on the road), security surveillance (e.g., automatic, real-time monitoring of a building or complex), monitoring of an alarm condition (e.g., in a residential building, at a corporate storage facility, etc.), billing transactions (e.g., credit card or debit card activity), inventory management (e.g., through monitoring of Point of Sale (POS) transactions in a supermarket), and the like. Many M2M devices are detection instruments with deployment over large geographical areas and relatively low access to power. The M2M communications typically use MTC-capable sensors or diagnostic devices (which may perform the metering, monitoring, etc., mentioned earlier) on one end and an M2M user device, receiver or server on the other end to receive data (e.g., wirelessly via a cellular Access Network (AN) as discussed below with reference to FIG. 1) from the sensor devices and process the data as per desired M2M service (e.g., utility metering service, healthcare monitoring service, alarm monitoring service, billing preparation service, and the like).

M2M communications are expected to contribute heavily to connectivity and traffic within the mobile broadband industry. The GSM/EDGE system (where “GSM” refers to Global System for Mobile communications and “EDGE” refers to Enhanced Data Rate for GSM Evolution systems) already serves a rapidly expanding market for MTC. Mobile communications operators have shown interest to accommodate traffic serving wireless sensors/devices within their modern evolved networks, such as those based on Third Generation Partnership Project's (3GPP) Long Term Evolution (LTE). As part of this, it would also be incumbent on the operators to handle MTC traffic served by existing cellular networks (such as GSM/EDGE networks), and to also provide a transition for such traffic from, e.g., General Packet Radio Service (GPRS)/EDGE to future versions of cellular systems such as International Mobile Telecommunications-Advanced (IMT-Advanced) systems (e.g., 3GPP LTE Advanced or LTE-A systems).

Prior to proceeding further, it is noted here that, in the discussion below, the terms “M2M terminal,” “MTC terminal,” “MTC device,” “M2M device,” or other such terms of similar import may be used interchangeably for ease of discussion. It is understood that an “M2M terminal” is a device, sensor, or instrument that is capable of only M2M communication in a wireless manner. Depending on a given context, the term “M2M terminal” may refer to an M2M Device or an M2M Gateway (GW) or both, whether stationary/fixed or mobile. In general, an M2M terminal is a low-power, limited-functionality (and processing capability) device, which is structurally and functionally significantly inferior to a User Equipment (UE). Although a UE or a Mobile Station (MS) (also known by various analogous terms such as “mobile handset,” “wireless handset,” “mobile terminal,” etc.) may be capable of M2M communication (through proper configuration thereof), such UEs or mobile handsets are not treated as M2M terminals in the discussion below so as to maintain distinctions between M2M-specific aspects (related to M2M terminals and M2M terminal-based communication) and UE-specific aspects (related to UEs and UE-based communication) discussed in more detail below. Some examples of UE's or mobile handsets/devices include cellular telephones or data transfer equipments (e.g., a Personal Digital Assistant (PDA) or a pager), smartphones (e.g., iPhone™, Android™ phones, Blackberry™, etc.), handheld or laptop computers, Bluetooth® devices, electronic readers, portable electronic tablets, etc.

Thus, although UE-based communication may also include M2M communication, such M2M communication aspect is not included as part of the terms “UE” and “UE traffic” (and other terms of similar import) as used hereinbelow. Rather, the terms “UE” and “UE traffic” are used primarily in conjunction with UE-based communication involving human users—i.e., Human-to-Human (H2H) (e.g., voice calls, Short Messaging Service (SMS) or text messaging, etc.) communication, and Human-to-Machine (H2M) communication (e.g., web browsing, video streaming, etc.) communication. On the other hand, the terms “M2M terminal” and “M2M traffic” (and other terms of similar import) are used in conjunction with M2M communication only. In this manner, involvement and experience of a UE's human user (in H2H and H2M communication) is clearly distinguished from a purely machine-based communication via M2M terminals. Thus, in summary, the term “UE traffic” includes H2H/H2M communication (e.g., a voice call, a video chat, a text or multimedia message from one human user to the other, web browsing etc.) from/to UEs only, whereas the term “M2M traffic” only includes M2M communication and only from/to M2M terminals. The terms “H2H” and “H2M” may imply presence of human users (including, for example, the increasing number of Mobile Broadband (MBB) users) of UEs, as well as active involvement or participation of such users in the communication. Whereas, the term “M2M” may primarily signify purely machine-to-machine communication, with human participation limited to supervision or monitoring/review of sensor data/inputs from M2M terminals in the field.

FIG. 1 illustrates a traditional wireless system 10 serving M2M terminals 12-13 and UEs 15-16 through a mobile communication network 18. In the discussion herein, the terms “wireless network,” “mobile communication network,” or “carrier network” may be used interchangeably to refer to a wireless communication network facilitating voice and/or data communication with wireless devices (like the devices 12-13 and 15-16). The wireless network 18 may be a dense network with a large number of wireless terminals (e.g., a large number of UE's along with a large number of sensors or MTC devices) operating therein. For ease of illustration, only four such devices 12-13 and 15-16 are shown in FIG. 1. The carrier network 18 may support stationary (e.g., M2M sensors) as well as mobile devices (e.g., UEs or certain M2M terminals). The mobile communication network 18 may be a cellular carrier network operated, managed, and/or owned by a wireless service provider (or operator). The carrier network 18 may serve the M2M terminals 12-13 and the UEs 15-16 through device-specific radio links 20-23 established between each of these wireless devices and a base station 25 (which may provide radio interface (in the form of the Radio Frequency (RF) links 20-23) to devices 12-13 and 15-16 via an antenna unit 26) in the carrier network 18. Thus, terminals operating in a wireless network may exchange information (which includes data, scheduling and control information, feedback information, etc.) via a base station in the network over a communication channel or link (e.g., an RF channel) between the base station and the wireless terminals (M2M and non-M2M).

As noted before, each of the M2M devices 12-13 may be a simple terminal with limited processing capability. For example, the MTC device 12-13 may be a sensor (e.g., a wireless picture or video camera installed at a corporate warehouse) for various machine-to-machine applications that send data to a base station, or a sensor attached to a home electrical meter to wirelessly report the meter reading to a base station, or a sensor placed on ground (e.g., for monitoring and wirelessly reporting seismic activity) and communicating with a stationary or mobile (e.g., on an airplane) base station, or a sensor attached to a mobile truck to monitor cargo movement, etc. Such terminals may be small and cheap, with a single antenna (for transmission as well as reception).

The base station 25 may be part of an Access Network (AN) (not shown) portion of the carrier network 18. The AN may be a 3GPP cellular AN or an International Mobile Telecommunication (IMT) Radio Access Network (RAN) such as, for example, a Universal Terrestrial Radio Access Network (UTRAN), an Evolved-UTRAN (E-UTRAN), a GSM/EDGE RAN (GERAN), a Worldwide Interoperability for Microwave Access (WiMAX) network, and the like.

In case of cellular access, the term “access network” may include not only a RAN portion (comprising, for example, a base station with or without a base station controller) of a cellular carrier network, but other portions (e.g., cellular backhaul and core network) as well. In FIG. 1, an exemplary IMT Core Network (CN) is shown using reference numeral “28.” As is understood, a cellular AN may include multiple cell sites (not shown), each under the radio coverage of a respective base station (BS) or base transceiver station (BTS). The base station 25 may be, for example, a legacy eNodeB (or eNB), high power and macro-cell base station or relay node, etc. The legacy eNB 25 may be a traditional eNB lacking functionalities of the eNB 39 discussed later below with reference to FIG. 3. The base station 25 may receive wireless communication from various MTC devices (like M2M terminals 12-13) and mobile terminals (like UEs 15-16), and forward the received communication to the Core Network 28. In case of a Third Generation (3G) RAN, for example, the base station 25 may include cellular backhaul (not shown) having functionalities of a 3G Radio Network Controller (RNC) or Base Station Controller (BSC). The base station 25 and some of the portions of its backhaul (such as, for example, a BSC or an RNC) may be considered to comprise the RAN portion of the network. The Core Network (CN) 28, on the other hand, may provide logical, service, and control functions (e.g., subscriber account management, billing, subscriber mobility management, etc.), Internet Protocol (IP) connectivity and interconnection to other networks (e.g., the Internet or the Internet-based service network 30) or entities, roaming support, etc. The CN 28 may be, for example, an IMT CN such as a 3GPP CN or a 3GPP2 CN (for Code Division Multiple Access (CDMA) based cellular systems), or an ETSI TISPAN (European Telecommunications Standards Institute TIPHON (Telecommunications and Internet Protocol Harmonization over Networks) and SPAN (Services and Protocols for Advanced Networks)) CN. In case of LTE, the CN 28 may include some or all functionalities of an Evolved Packet Core (EPC).

The carrier network 18 may eventually connect the M2M devices 12-13 to an Internet-based service network 30 that may host an M2M server (not shown) from an M2M Service Provider (SP). The server may remotely control or “operate” the M2M terminals 12-13 as well as receive and process data sent by these devices. For example, if an MTC terminals is a building surveillance sensor or unit, the M2M server in that case may be a remote data collection/processing unit that may instruct the surveillance sensor to transmit surveillance data thereto at predefined time intervals (so as, for example, not to overload cellular network resources). It may be possible that the M2M service provider is also the operator or provider of the cellular and/or fixed access networks. On the other hand, the M2M SP may be independent of the cellular AN operator, but may have a business relationship with the cellular network operator for interoperability purposes.

The CN 28 may function to provide connection of the base station 25 to other terminals (M2M or non-M2M) (not shown) operating in the carrier network 18 and also to other communication devices (e.g., wireline or wireless phones, computers, monitoring units, etc.) or resources (e.g., an Internet website) in other voice and/or data networks (not shown) external to the carrier network 18. In that regard, the CN 28 may be coupled to a packet-switched network (e.g., the IP network 30, such as the Internet) as well as a circuit-switched network 31, such as the Public-Switched Telephone Network (PSTN), to accomplish the desired connections beyond the carrier network 18.

It is observed here that some of the M2M terminals operating in the network 18 may be wirelessly interconnected with one another, with other similar entities (not shown), or with one or more M2M Gateways (not shown). It is noted here that an M2M terminal may be a Direct Access M2M device that supports direct access to an access network, or an Indirect Access M2M device that does not support direct access to an access network. An M2M gateway may be used to support network access for such Indirect Access M2M devices. The M2M Gateway may function as a concentrator of data received from various such Indirect Access M2M devices communicating therewith. The wireless AN may further support inter-domain communication between two or more M2M devices (operating under different base stations) without the involvement of the M2M service provider's server. In other words, the system 10 in FIG. 1 allows M2M communications among two or more M2M devices/sensors 12-13 (via the network 18), and also between one or more of these devices and their respective networks.

In case of wireless devices used in M2M communication, data transmissions occur mainly in the uplink (i.e., from the device to the network), whereas the downlink (from the network to the device) serves mainly for transmitting feedback and link control information to M2M devices. A “scheduler” is used in a wireless network (e.g., as part of a base station in a cellular network such as a 3GPP LTE network) to determine to/from which terminal(s) to transmit/receive data and on which set of radio resource(s) in the different domains (time, frequency, etc.) of the communication system. A scheduler is a key element of the network and, to a large extent, determines the overall behavior of the system. In LTE, the scheduler controls the assignment of uplink and downlink radio resources. The eNodeB makes a scheduling decision for each 1 ms of Transmission Time Interval (TTI) (i.e., 1 ms subframe of a 10 ms radio frame in LTE) and sends scheduling information to the selected set of terminals. Uplink and downlink scheduling are separated in LTE, and uplink and downlink scheduling decisions can be taken independently of each other. In LTE, the basic scheduling operation is so-called dynamic scheduling, where the eNodeB sends scheduling information in each 1 ms TTI (or subframe) to the selected set of terminals, controlling the uplink and downlink transmission activity. The terminal follows scheduling commands, for both uplink and downlink, from a single cell only—i.e., the serving cell.

Although the scheduling strategy is implementation-specific and not specified by 3GPP, an LTE scheduler still plays an important role in distributing radio resources to UEs and M2M terminals. As mentioned earlier, demand for M2M communication over cellular wireless network has recently seen a rapid growth. The 4G LTE wireless network is expected to be used for the majority of the M2M traffic. M2M communication over 4G networks faces some challenges. The main challenge is how to accommodate the massive number of M2M devices without negatively impacting the human subscribers' Quality of Experience (QoE).

It is noted here that because the inventive aspects of the present disclosure are discussed later with reference to an LTE system, the discussion below now provides general background information about scheduling in LTE. Similar scheduling approaches may be present in other non-LTE systems as well, but, for the sake of brevity, only the LTE system is discussed below. However, such LTE-limited discussion should not be construed to limit the scope of the present disclosure to LTE-based systems only. Rather, as mentioned later, the teachings of the present disclosure can be applied to other non-LTE systems as well.

LTE is designed to support end-to-end Quality of Service (QoS). The main mechanism for QoS support in LTE are the QoS Class Identifier (QCI) values. QCI is a scalar that is used as a reference to node-specific parameters that control packet forwarding treatment (e.g., scheduling weights, queue management thresholds, packet loss rate, packet delay budget, link layer protocol configuration, etc.) and that have been pre-configured by the operator owning/operating the node (e.g., the eNB 25 in FIG. 1).

FIG. 2 shows a table 33 listing currently-standardized QCI values in LTE for different types of wireless communications. A more detailed version of the table 33 in FIG. 2 may be obtained by consulting, for example, the table 6.1.7 in 3GPP Technical Specification (TS) 23.203, version 11.8.0 (December 2012), titled “3GPP: TS Group Services and System Aspects; Policy and Charging Control Architecture (Release 11).” Standardization of a QCI with corresponding characteristics (e.g., “Resource Type” of the QCI, “Priority” level for the QCI, etc.) ensures that applications/services mapped to that QCI receive the same minimum level of QoS in multi-vendor network deployments and also in case of roaming, regardless of a UE's or MTC device's current access (3GPP or non-3GPP).

In FIG. 2, the one-to-one mapping between nine (9) standardized QCI values and some of the standardized characteristics is shown. The standardized characteristics shown in FIG. 2 include (i) the “Resource Type” of a particular QCI value—i.e., whether the QCI value is a Guaranteed Bit Rate (GBR) QCI value or a non-GBR QCI value, and (ii) a “Priority” level (on a scale of 1 through 9) associated with that QCI value. The “Resource Type” (or, simply the “Type”) may determine if dedicated network resources (e.g., radio resources) related to a service or bearer level GBR value are permanently allocated. As shown in FIG. 2, every QCI (GBR and non-GBR) is associated with a “Priority” level, which may be used as a basis for assigning the uplink (UL)/downlink (DL) priority per radio bearer. Priority level “1” is the highest priority level, and priority level “9” is the lowest priority level. Thus, for example, it is seen from the table 33 in FIG. 2 that the non-GBR QCI value=5 (related to IP Multimedia Subsystem (IMS) related signaling traffic) has the highest priority level, whereas the non-GBR QCI value=9 (related to buffered streaming of video data or Transmission Control Protocol (TCP)-based data (e.g., World Wide Web (www) surfing, e-mail, chat, File Transfer Protocol (FTP) file transfer, Person-to-Person (P2P) file sharing, etc.)) has been assigned the lowest priority level. Other service applications (e.g., conversational voi9ce, real-time gaming, etc.) have priority levels between these two ranges as shown in FIG. 2. For the sake of brevity, these services and their associated Resource Types and Priority levels are not discussed here in view of the details shown in the table 33 in FIG. 2.

In LTE, each IP bearer has an associated QCI that determines how the bearer is handled in the LTE eNodeB (e.g., the eNB 25 in FIG. 1) and the Evolved Packet Core (EPC) (e.g., the CN 28). As mentioned earlier, the LTE scheduler plays an important role in distributing radio resources to UEs and M2M terminals. Existing priority-based schedulers in LTE use the QCI values from the table 33 for the UE traffic as well as the M2M traffic. In other words, the M2M traffic bearers are also mapped into one of the existing QCIs shown in FIG. 2.

### SUMMARY

It is observed that existing LTE priority-based schedulers do not differentiate between UEs (e.g., UEs 15-16 in FIG. 1) engaged in H2H/H2M communication and M2M terminals (e.g., M2M terminals 12-13 in FIG. 1) performing M2M communication because existing QCI definition (as shown in the table 33 in FIG. 2) does not have any M2M-specific QCI classes. As a result, to provide M2M traffic bearers with different QCI classification levels, the schedulers use one approach in which M2M traffic bearers are mapped into the same QCIs as those used for H2H/H2M bearers—i.e., the QCIs shown in FIG. 2. In case of a large deployment of M2M terminals within the carrier network (e.g., the network 18 in FIG. 1), this approach, however, results in a large number of M2M terminals competing for the network resources (e.g., radio resources) with H2H/H2M UEs at the same QCI priority. Such competition can degrade the H2H/H2M users' Quality of Experience (QoE) in a network with large number of M2M terminals.

It is therefore desirable to devise an LTE scheduling approach that differentiates between M2M traffic and UE traffic. It is further desirable to preserve human users QoE, while allowing the network operators to accommodate the projected large number of M2M terminals in their networks without any significant investment in new radio equipment.

As a solution, particular embodiments of the present disclosure provide an M2M-aware time domain hybrid scheduler for LTE that differentiates between M2M and UE traffic (in the uplink and the downlink). In one embodiment, prior to allocation of radio resources to UEs and M2M terminals (in the uplink and/or downlink), the available bandwidth (i.e., radio resources available over a given scheduling interval) is divided into two disjoint sets—a UE-specific set (dedicated for H2H/H2M users (i.e., operators of UEs)) and an M2M-specific set (dedicated for M2M terminals). The hybrid scheduler allocates radio resources to M2M terminals from the M2M-specific set only. Any unallocated radio resource from the M2M-specific set and the radio resources assigned to the UE-specific set are then allocated to the UEs (of H2H/H2M users). If radio resources in the M2M-specific set are insufficient to accommodate all resource-requesting M2M terminals, some M2M terminals may not be scheduled at all during a specific scheduling interval. The hybrid scheduler will not use resources from the UE-specific set to accommodate such M2M terminals during the specific scheduling interval.

Furthermore, the present disclosure also proposes new M2M-specific QCIs (some examples of which are shown in FIG. 5 and discussed later below) to facilitate end-to-end QoS for M2M traffic without impacting H2H/H2M users' QoE. The new M2M-specific QCIs are for classifying M2M traffic only—i.e., these new QCIs are disjoint from the existing QCI values (shown in the table 33 in FIG. 2) to preserve the uniqueness of the new QCI values. The proposed M2M-specific classification is relative to M2M traffic only, rather than to the overall network traffic (which may include M2M as well as UE traffic). Thus, the new M2M-specific QCIs separate M2M traffic classification from UE traffic classification (using the QCIs in FIG. 2) so as not to impact UE human users' QoE from M2M terminals competing for the network resources at the same QCI priority.

In one embodiment, the present disclosure is directed to a method in a mobile communication network for scheduling radio resources among a plurality of Machine-to-Machine (M2M) terminals being utilized for M2M communication and a plurality of User Equipments (UEs) being utilized for UE-based communication. The M2M terminals and the UEs are in wireless communication with a network entity that allocates radio Resource Units (RUs) to the UEs and the M2M terminals in the mobile communication network. The method comprises the following: (i) prior to allocation of any RU by the network entity over a pre-defined scheduling interval, dividing all RUs that are available for allocation during the pre-defined scheduling interval into a first set of RUs dedicated to M2M terminals and a second set of RUs dedicated to UEs, wherein the first and the second sets are disjoint sets; (ii) the network entity allocating RUs only from the first set to one or more M2M terminals; and (iii) the network entity allocating only remaining RUs to one or more UEs, wherein the remaining RUs are selected from the following: all unallocated RUs from the first set, and all RUs from the second set.

In another embodiment, the present disclosure is directed to a method for scheduling radio resources among a plurality of UEs and a plurality of M2M terminals using a network entity that utilizes Quality of Service Class Identifier (QCI) values in determining allocation of radio Resource Units (RUs) to the UEs and the M2M terminals. The method comprises defining a first set of QCI values only for M2M traffic from/to the M2M terminals, wherein the first set of QCI values is disjoint from a second set of QCI values to be used for communication traffic from/to the UEs.

In a further embodiment, the present disclosure is directed to a method for scheduling radio resources among a plurality of UEs and a plurality of M2M terminals that are in wireless communication with a network entity in a mobile communication network, wherein the network entity allocates radio RUs to the UEs and the M2M terminals. The method comprises performing the following using the network entity: (i) selecting RUs to be allocated to one or more M2M terminals only from a first set of RUs containing p % of all RUs that are available for allocation over a pre-defined scheduling interval; (ii) allocating the selected RUs to the one or more M2M terminals; (iii) selecting remaining RUs to be allocated to one or more UEs from the following: all RUs from the first set of RUs that are not allocated to the one or more M2M terminals, and a second set of RUs containing (1−p) % of all RUs that are available for allocation over the pre-defined scheduling interval, wherein the first and the second sets of RUs are disjoint sets, and wherein the value of “p” is determined before the available RUs are divided into the first and the second sets; and (iv) allocating the selected remaining RUs to the one or more UEs.

In a still further embodiment, the present disclosure is directed to a mobile communication node that is configured to schedule radio resources among a plurality of UEs and a plurality of M2M terminals that are in wireless communication with the mobile communication node in a mobile communication network. The mobile communication node comprises: a transceiver configured to transmit and receive wireless signals to/from the UEs and the M2M terminals; and a scheduler coupled to the transceiver and configured to send radio resource scheduling information to the UEs and the M2M terminals via the transceiver. The scheduler is configured to perform the following: (i) allocate up to p % of all radio Resource Units (RUs) that are available for allocation over a pre-defined scheduling interval only to one or more M2M terminals, and (ii) allocate to one or more UEs only those RUs that are selected from the group consisting of: any RU that remains unallocated to the M2M terminals, and the remaining (1−p) % of the total RUs available for allocation over the pre-defined scheduling interval, wherein the value of “p” is determined prior to allocation of any RU over the pre-defined scheduling interval.

In another embodiment, the present disclosure is directed to a mobile communication node that is configured to schedule radio resources among a plurality of UEs and a plurality of M2M terminals that are in wireless communication with the mobile communication node in a mobile communication network. The mobile communication node is further configured to perform the following: (i) select radio RUs to be allocated to one or more M2M terminals only from a first set of RUs containing p % of all RUs that are available for allocation during a pre-defined scheduling interval; (ii) allocate the selected RUs to the one or more M2M terminals using one or more QCI values only from an M2M-specific set of QCI values, wherein the M2M-specific set contains QCI values defined only for M2M traffic from/to the M2M terminals, and wherein the M2M-specific set of QCI values is disjoint from a UE-specific set of QCI values to be used for UE traffic from/to the UEs; and (iii) using one or more QCI values only from the UE-specific set, allocate to one or more UEs only those RUs that are selected from the following: all RUs from the first set that are not allocated to the one or more M2M terminals, and all RUs from a second set of RUs containing (1−p) % of all RUs that are available for allocation during the pre-defined scheduling interval, wherein the first and the second sets are disjoint sets, and wherein the value of “p” is determined before the available RUs are divided into the first and the second sets.

Thus, in the exemplary case of 3GPP LTE cellular network, certain embodiments of the present disclosure preserve human users' QoE by dividing the available bandwidth between human users and M2M terminals, and providing a hybrid scheduler that schedules the M2M terminals only over the M2M-specific portion of the bandwidth. Introduction of QCI values defined exclusively for classifying M2M traffic facilitates end-to-end QoS for M2M traffic without impacting H2H/H2M users' QoE. The combination of bandwidth division and new M2M-specific QCI values allows network operators to accommodate a large number of M2M terminals in their networks without any significant investment in new radio equipment.

### BRIEF DESCRIPTION OF THE DRAWINGS

In the following section, the present disclosure will be described with reference to exemplary embodiments illustrated in the figures, in which:

FIG. 1 illustrates a traditional wireless system serving M2M terminals and UEs through a mobile communication network;

FIG. 2 shows a table listing currently-standardized QCI values in LTE for different types of wireless communications;

FIG. 3 is a diagram of an exemplary wireless system in which the hybrid scheduling methodology according to the teachings of one embodiment of the present disclosure may be implemented;

FIG. 4 illustrates an exemplary flowchart depicting various steps of the hybrid scheduling methodology according to one embodiment of the present disclosure;

FIG. 5 shows an exemplary table listing new M2M-specific QCI values for classifying M2M traffic in an LTE network according to the teachings of one embodiment of the present disclosure; and

FIG. 6 depicts a block diagram of an exemplary network entity according to one embodiment of the present disclosure.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context of a 3GPP cellular telephone/data network, but it can be implemented in other forms of cellular or non-cellular wireless networks as well.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “TCP-based,” “M2M-specific,” “pre-defined,” etc.) may be occasionally interchangeably used with its non-hyphenated version (e.g., “TCP based,” “M2M specific,” “predefined,” etc.), a capitalized entry (e.g., “Uplink,” “Resource Unit,” Guaranteed Bit Rate”, etc.) may be interchangeably used with its non-capitalized version (e.g., “uplink,” “resource unit,” “guaranteed bit rate”, etc.), and plural terms may be indicated with or without an apostrophe (e.g., UE's or UEs, RU's or RUs, etc.). Such occasional interchangeable uses shall not be considered inconsistent with each other.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale,

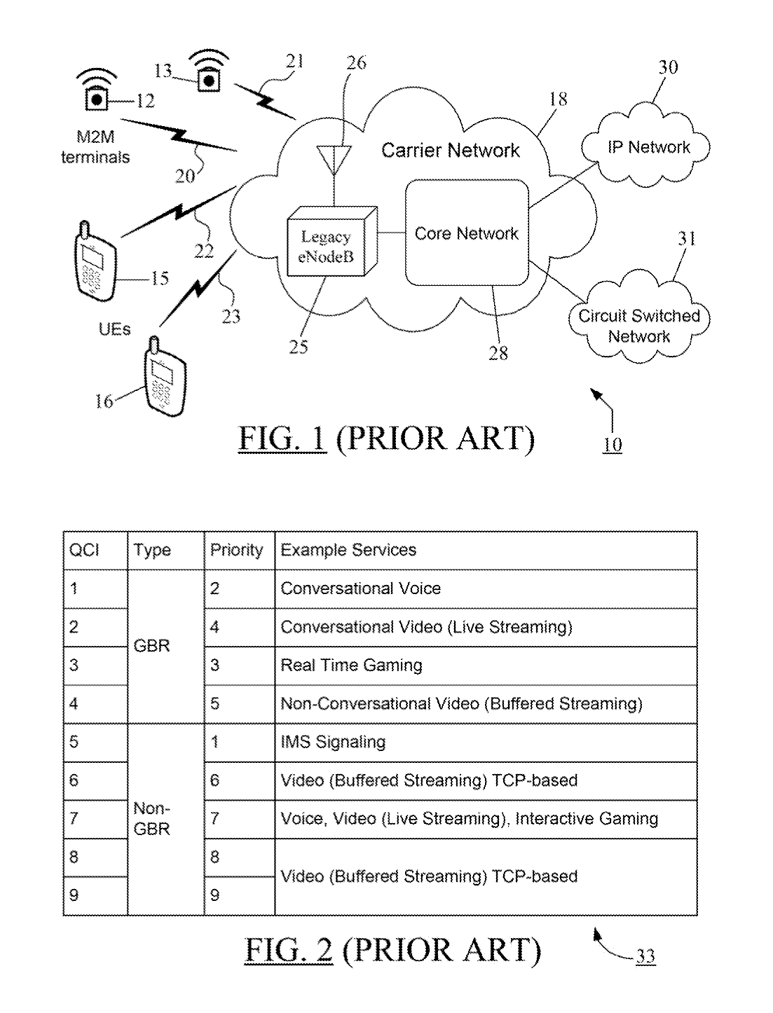

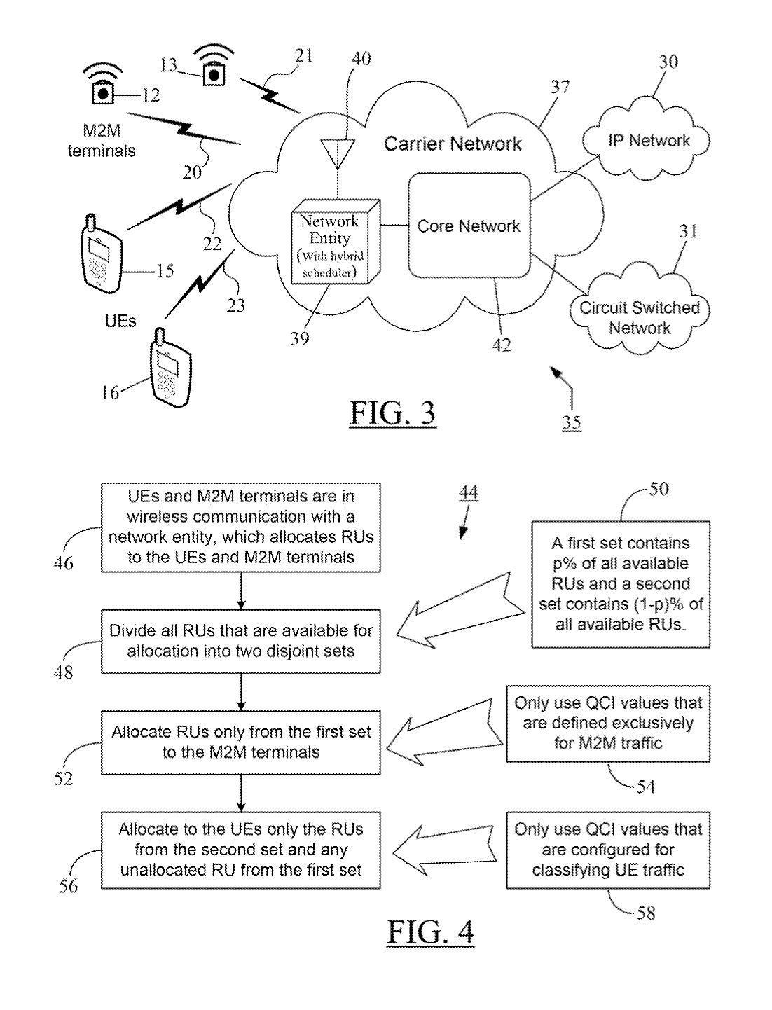

FIG. 3 is a diagram of an exemplary wireless system 35 in which the hybrid scheduling methodology according to the teachings of one embodiment of the present disclosure may be implemented. It is noted here that entities having similar configurations or functionalities—e.g., M2M terminals 12-13, UEs 15-16, IP network 30, etc.—are identified using the same reference numerals in FIGS. 1 and 3 for the sake of simplicity and ease of discussion. Hence, earlier discussion of such entities with reference to FIG. 1 remains applicable in the context of FIG. 3 and, therefore, is not reproduced in detail below for the sake of brevity. The carrier network 37 (and its constituent components—like the eNB 39 and the Core Network 42) in FIG. 3 is, however, different from the carrier network 18 with legacy eNB 25 in FIG. 1 because the eNodeB 39 in the carrier network 37 may implement the hybrid scheduling methodology (in conjunction with the core network 42, if needed) according to particular embodiments of the present disclosure, as discussed later with reference to FIGS. 4-6.

The devices 12-13 and 15-16 in the system 3 are shown to be in wireless communication (via respective radio links 20-23) with the wireless network 37 through a network entity (also interchangeably referred to herein as a “base station,” “mobile communication node,” or simply a “node”) 39 of the network 37. The network 37 may be operated, managed, and/or owned by a wireless service provider (or operator). The network entity 39 may be, for example, a base station in a 3G network, or an evolved Node-B (eNodeB or eNB) when the carrier network is an LTE network, and may provide radio interface (e.g., an RF channel) to the wireless devices 12-13 and 15-16 via an antenna (or antenna unit) 40. The radio interface is depicted by the exemplary wireless links 20-23. In other embodiments, the network entity 39 may also include a site controller, an access point (AP), a radio tower, or any other type of radio interface device capable of operating in a wireless environment. In one embodiment, the base station 39 may be configured to implement an intra-cell or inter-cell Coordinated Multi-Point (COMP) transmission/reception arrangement. In addition to providing air interface or wireless channel (e.g., as represented by wireless links 20-23 in FIG. 3) to the devices 12-13, 15-16 via antenna 40, the communication node (or base station) 39 may also perform radio resource management (as, for example, in case of an eNodeB in an LTE system) using, for example, a hybrid scheduler (e.g., the scheduler 70 shown in FIG. 6) configured according to particular embodiments of the present disclosure.

In case of a 3G carrier network 37, the network entity 39 may include functionalities of a 3G base station along with some or all functionalities of a 3G Radio Network Controller (RNC). Various base stations—whether 3G base stations or base stations in other types of carrier networks (e.g., Fourth Generation (4G) networks and beyond)—may be configured as discussed below to implement the hybrid scheduling solution according to particular embodiments of the present disclosure. For example, in one embodiment, the base station 39 may be configured (in hardware, via software, or both) to implement the hybrid scheduling methodology as discussed herein. For example, when existing hardware architecture of the base station 39 cannot be modified, the hybrid scheduling methodology according to one embodiment of the present disclosure may be implemented through suitable programming of one or more processors and/or schedulers (e.g., processor 62 (or, more particularly, the processing unit 68) and scheduler 70 in FIG. 6) in the network entity 39. The execution of the program code (by a processor and/or scheduler in the node 39) may cause the processor and scheduler to perform appropriate method steps—e.g., division of Resource Units (RU's) into disjoint sets, and M2M-specific and UE-specific allocation of RU's using corresponding QCI values—which are illustrated in FIG. 4 (discussed later below). Thus, in the discussion below, although the network entity 39 may be referred to as “performing,” “accomplishing,” or “carrying out” a function or process, such performance may be technically accomplished in hardware and/or software as desired.

As mentioned earlier, the terms “wireless network,” “mobile communication network,” or “carrier network” may be used interchangeably herein to refer to a wireless communication network (e.g., a cellular network, a proprietary data communication network, a corporate-wide wireless network, etc.) facilitating voice and/or data communication with different types of wireless devices (like M2M terminals 12-13 and UE's 15-16). The wireless network 37 may be a dense network with a large number of wireless devices (e.g., a large number of UE's along with a large number of sensors or other M2M terminals) operating therein. As mentioned earlier, the M2M terminals 12-13 may be fixed (primarily stationary) or mobile. In any event, it is understood that the carrier network 37 may support stationary as well as mobile devices (whether UE's or M2M terminals).

The carrier network 37 may include a network controller 42 coupled to the base station 39 and providing logical and control functions (e.g., terminal mobility management, access to external networks or communication entities, subscriber account management, etc.) in the network 37. In case of an LTE carrier network, the network controller 42 may be a Core Network (CN), which may be an Access Gateway (AGW) or an Evolved Packet Core (EPC). Regardless of the type of carrier network 37, the network controller 42 may function to provide connection of the base station 39 to other wireless terminals (not shown) operating in the carrier network 37 and also to other communication devices (e.g., wireline or wireless phones, computers, monitoring units, etc.) or resources (e.g., an Internet website) in other voice and/or data networks (not shown) external to the carrier network 37. In that regard, the network controller 42 may be coupled to a packet-switched network (e.g., the IP network 30, such as the Internet) as well as the circuit-switched network 31 (such as the Public-Switched Telephone Network (PSTN)) to accomplish the desired connections beyond the carrier network 37.

The carrier network 37 may be a cellular telephone network, a Public Land Mobile Network (PLMN), or a non-cellular wireless network (whether voice network, data network, or both). The wireless terminals—i.e., the M2M terminals 12-13 and the UEs 15-16—may be subscriber units in the carrier network 37. Furthermore, portions of the carrier network 37 may include, independently or in combination, any of the present or future wireline or wireless communication networks such as, for example, the PSTN, an IP Multimedia Subsystem (IMS) based network, or a satellite-based communication link. Similarly, as also mentioned above, the carrier network 37 may be connected to the Internet via its core network's 42 connection to the IP network 30 or may include a portion of the Internet as part thereof. In one embodiment, the wireless network 37 may include more or less or different types of functional entities than those shown in FIG. 3.

Although various examples in the discussion below are provided primarily in the context of the wireless network 37 being an IP-based 3GPP/3GPP2 cellular network (e.g., an LTE network), the teachings of the present disclosure may equally apply, with suitable modifications, to a number of other shared common channel networks/systems (cellular or non-cellular) such as WiMAX systems, International Mobile Telecommunications-Advanced (IMT-Advanced) systems (e.g., LTE Advanced systems), etc., where radio resources are “scheduled” to a wireless terminal (M2M as well as non-M2M) by a network-based entity (e.g., a base station).

FIG. 4 illustrates an exemplary flowchart 44 depicting various steps of the hybrid scheduling methodology according to one embodiment of the present disclosure. As indicated at block 46 in FIG. 4, UEs 15-16 and M2M terminals 12-13 may be in wireless communication with the network entity 39 in the carrier network 37. In one embodiment, some or all of these wireless terminals (UEs and M2M devices) may send scheduling requests to the network entity 39 for allocation of radio resources in the uplink/downlink. In response to such scheduling requests, the network entity 39 may allocate Resource Units (RUs) to the UEs 15-16 and M2M terminals 12-13. In particular embodiments, the network entity 39 may be configured to allocate RUs without the need to receive corresponding scheduling requests. An RU may be the smallest assignable radio resource configuration—over a pre-defined scheduling interval—by a scheduler (e.g., the hybrid scheduler 70 shown in FIG. 6) in the network entity 39 (e.g., an LTE eNodeB). In LTE, two Resource Blocks (RB's) or “slots” (each of 0.5 ms duration) in a given scheduling interval may constitute a single RU. The pre-defined scheduling interval may be the Transmission Time Interval (TTI) of 1 ms duration (i.e., each 1 ms sub-frame of the 10 ms radio frame in LTE). Thus, a scheduler in the network entity 39 may schedule multiple wireless terminals (M2M as well as non-M2M) over a given scheduling interval by allocating them appropriate radio resources (in the form of one or more RUs, the number of which may be determined by the scheduler based on the QCI classification associated with the service for which RUs are to be allocated). This scheduling facilitates wireless terminals' communication with the network entity 39.

It is noted here that existing LTE schedulers do not limit M2M traffic. That is, existing schedulers use the whole available bandwidth (over a specific TTI) to schedule all IP bearers, without distinguishing between M2M traffic and UE traffic (i.e., H2H/H2M traffic). As a result, M2M terminals end up competing with UEs for the limited network resources available during a given scheduling interval. On the other hand, in one embodiment of the present disclosure, the M2M traffic (from/to M2M terminals) is separated from the UE traffic (from/to UEs), and the scheduler (e.g., the hybrid scheduler 70 shown in FIG. 6) in the eNB 39 is configured to enforce this separation. In one embodiment, the eNB scheduler (e.g., the scheduler 70 in FIG. 6) may distinguish between the M2M traffic and the UE traffic in both the uplink and the downlink using the methodology illustrated in FIG. 4. As shown at block 48 in FIG. 4, in one embodiment, such traffic separation may be accomplished by dividing the available bandwidth into two disjoint sets. Hence, all RUs that are available for allocation during the pre-defined scheduling interval (e.g., a TTI) are divided into two disjoint sets—a first set contains p % of these RUs and a second set contains (1−p) % of these RUs, as indicated at block 50 in FIG. 3. In one embodiment, with reference to a given scheduling interval, the division of RUs may be carried out before any RU is allocated over that scheduling interval. Hence, in one embodiment, the value of “p” may be determined (as discussed below) prior to such division. After the RUs are divided, the hybrid scheduler may allocate RUs only from the first set to one or more M2M terminals in the network 37, as indicated at block 52 in FIG. 4. Hence, the scheduler does not leave the number of RUs allocated to M2M traffic to chance, but rather deterministically allocates no more than p % of the total RUs at any time (i.e., during a specific TTI) to M2M terminals to be scheduled. As a result, in one embodiment, the size of the two disjoint sets is deterministically enforced, and that will substantially guarantee that human users (of UEs) are favored against M2M devices.

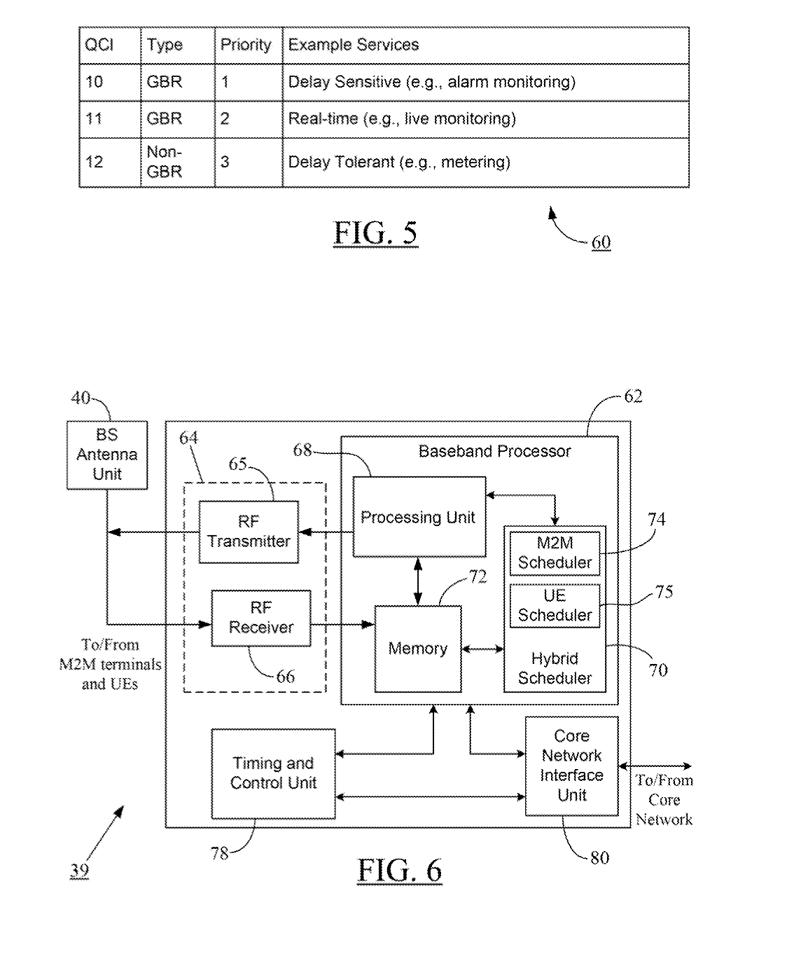

As mentioned earlier, the present disclosure also provides for a set of QCI values (some examples of which are shown in FIG. 5 and discussed later below) defined exclusively for classifying the M2M traffic. This M2M-specific set of QCI values is disjoint from the currently-standardized set of QCI values (in FIG. 2), which are primarily configured for classifying the UE traffic. In one embodiment, during allocation of RUs to M2M terminals (at block 52), the scheduler in the eNB 39 may use only those QCI values that are defined exclusively for the M2M traffic (such as, e.g., the QCI values shown in FIG. 5) as indicated at block 54 in FIG. 4.

In case of the UEs in the network 37, the scheduler in the network entity 39 may allocate to eligible UEs (e.g., one or more UEs from the group of UEs requesting radio resources) only the following RUs: (i) the (1−p) % of the RUs from the second set (at block 50), and (ii) any RU that remains unallocated (at block 52) from the M2M-specific first set of RUs (at block 50). Such UE-specific allocation is indicated at block 56 in FIG. 4. In one embodiment, during allocation of RUs to UE's (at block 56), the scheduler in the network entity 39 may use only those QCI values that are primarily configured for classifying the UE traffic (block 58 in FIG. 4). Hence, in one embodiment, the scheduler in the eNodeB 39 will use only the currently-standardized set of QCI values from FIG. 2 during allocation of RUs to UEs; the scheduler will not use any M2M-specific QCI value from FIG. 5 during scheduling of UEs at block 56.

A detailed discussion of how RUs are divided (during a TTI) and what is contained in an M2M-specific set of QCI values is now provided with reference to FIGS. 4 and 5. In LTE, the total bandwidth or radio resources available for allocation during a given scheduling interval (i.e., a 1 ms TTI in LTE) is divided into “R” Resource Units (RU's). The existing scheduling algorithms allocate all of the “R” RUs among “n” H2H/H2M users based on the chosen optimization criteria (as reflected, e.g., by corresponding QCI values shown in FIG. 2). This can be mathematically expressed by the following linear inequality:

$${\sum }_{i = 1}^{n} {U}_{i} \leq R , \\ where \\ {U}_{i} = RUs assigned to an H 2 H / H 2 M user ( or UE ) '' i '' \qquad ( 1 )$$

In a system with a mix of “n” H2H/H2M users and “m” M2M terminals, the existing schedulers perform allocations of all RUs (over a given TTI) without distinguishing between M2M terminals and UEs. Such indiscriminate scheduling can be expressed by re-writing equation (1) as given below:

$${\sum }_{i = 1}^{n} {U}_{i} + {\sum }_{j = 1}^{m} {M}_{j} \leq R , \\ where \\ {M}_{j} = RUs assigned to an M 2 M terminal '' j '' \qquad ( 2 )$$

On the other hand, the present disclosure proposes dividing the number of available RUs (over a pre-defined scheduling interval, such as a TTI in LTE) into two disjoint sets (as shown at block 48 in FIG. 4)—a first set dedicated for M2M terminals, and a second set dedicated for UE users (as shown at block 50 in FIG. 4). As is known in mathematics, two sets are said to be “disjoint” if they have no element in common—such as, for example, sets {1, 2, 3} and {4, 5, 6}. In one embodiment, such disjoint division is performed before any RU is allocated (whether to M2M terminals or UE's) over the pre-defined scheduling interval.

In one embodiment, the size of each of these two sets can be configured by the network operator as a percentage of the available RUs—e.g., the and “(1−p) %” division shown at block 50 in FIG. 4. In one embodiment, the value of “p” may be variable. This percentage “p” may be dynamically adjusted to adapt to the traffic condition in the network. For example, in one embodiment, the value of “p” for a specific scheduling interval may be based at least on the number of M2M terminals and the number of UEs for which radio resources are to be allocated during that scheduling interval. As another example, the percentage “p” may be set to a very low value during H2H/H2M peak traffic period, and increased when the UE traffic (i.e., H2H/H2M traffic) is at its lowest. The increase in the value of “p” may be step-wise or linear/gradual increase.

The division of the available RUs (at block 48 in FIG. 4) may be performed by a processor suitably configured by for example, the network operator. In one embodiment, such processor may be part of the eNodeB 39 (e.g., the processing unit 68 in FIG. 6) or the CN 42. In another embodiment, the eNodeB scheduler itself (e.g., the scheduler 70 in FIG. 6) may be configured to perform such division prior to allocation. It is noted here that the processor in the eNodeB 39 (e.g., the processing unit 68 in FIG. 6) may be configured or programmed to perform determination and storage of the value of “p” and/or store a pre-determined value of “p” (e.g., in a case in which the value of “p” is not variable) in an associated memory (e.g., the memory 72 in FIG. 6). The processor may then provide the value of “p” to the eNodeB scheduler when RU's are to be allocated. Alternatively, in one embodiment, a processor (not shown) in the Core Network 42 may be configured (in hardware and/or software) to carry out such determination of value of “p” and provide it to the eNodeB 39 (and, hence, to the eNodeB-based scheduler). On the other hand, as mentioned earlier, the scheduler in the eNodeB 39 (e.g., the scheduler 70 in FIG. 6) may itself determine the value of “p” and allocate RUs as per the teachings of the present disclosure.

As mentioned earlier and shown at block 50 in FIG. 4, the size of the set dedicated for M2M terminals is p % of the total available RUs. In one embodiment, the present disclosure proposes a hybrid scheduler (e.g., the scheduler 70 shown in FIG. 6) that allocates no more than p % of available RUs to M2M terminals at each TTI. This can be mathematically expressed by the following equations (3) and (4).

$$\begin{matrix}{\sum }_{j = 1}^{m} {M}_{j} \leq pR \\ and & ( 3 ) \\ {\sum }_{i = 1}^{n} {U}_{i} \geq ( 1 - p ) R & ( 4 )\end{matrix}$$

Thus, as can be seen from equation (3), the scheduler according to one embodiment of the present disclosure (e.g., the scheduler 70 in FIG. 6) allocates RUs only from the first set (containing p % of all RUs available during a TTI) to eligible M2M terminals. Such allocation continues until all scheduling requests from the M2M terminals have been fulfilled or until all RUs in the first set have been allocated, whichever occurs first (as expressed in equation (3) above). Any RU that remains unallocated in the first set and all the RU's from the second set are then made available for allocation to eligible UE's, as expressed in equation (4) above. Contrary to existing schedulers, the scheduler in the eNodeB 39 thus does not leave the number of RUs allocated to M2M traffic to chance, but rather deterministically allocates no more than p % of total RUs to M2M terminals during a given scheduling interval (in the uplink and/or downlink). Such disjoint set-based RU allocation allows the scheduler in the eNodeB 39 to deterministically enforce separation between the M2M traffic and the UE traffic so as to substantially guarantee that human users are favored against M2M terminals.

As mentioned before, the existing LTE QCI definition (shown in table 33 in FIG. 2) does not have any M2M-specific QCI classes. This deficiency results in mapping of M2M traffic bearers into one of the existing QCIs (from table 33 in FIG. 2), thereby creating a competition between the M2M terminals and UEs for the network resources at the same QCI priority/scalar value. As also mentioned before, such competition can degrade the H2H/H2M users' QoE in a network with large number of M2M terminals. The QCI classification in the embodiment of FIG. 5 remedies this problem.

FIG. 5 shows an exemplary table 60 listing new M2M-specific QCI values for classifying M2M traffic in an LTE network (e.g., the carrier network 37 in FIG. 3) according to the teachings of one embodiment of the present disclosure. The classification in the table 60 in FIG. 5 is relative to the M2M traffic only, rather than to the overall network traffic (which may include UE traffic as well). Thus, the objective of separating the M2M traffic classification from the UE traffic classification is achieved because the QCI values in the table 60 are defined exclusively for classifying the M2M traffic only. In the table 60, three exemplary M2M-specific QCI's are shown for delay-sensitive, real-time, and delay-tolerant M2M data. A comparison of the table 33 in FIG. 2 and the table 60 in FIG. 5 shows that the scalar values of the new QCI's (i.e., the scalar values of “10,” ‘11,” and “12”) are disjoint from the existing QCI values (“1” through “9” in the table 33) to preserve the uniqueness of each QCI value.

In the embodiment of FIG. 5, the delay-sensitive M2M traffic has been assigned a QCI value of “10” and is classified as a Guaranteed Bit Rate (GBR) type with the highest priority, i.e., priority level “1”, relative to the other M2M traffic within the network 37. Delay-sensitive M2M traffic is characterized as high priority traffic that requires delivery to the receiver within a specified maximum delay. Late packets may still be useful but may result in undesirable processing delays. Delay-sensitive M2M traffic may include, for example, alarm condition-related monitoring data such as a fire alarm at a residential building or break-in at a corporate storage facility, seismic activity alerts, cardiac arrest alerts, and the like. Real-time M2M traffic (QCI value=11) is time constrained such that packets must be delivered within a certain time or, otherwise, the information will not be useful to the receiver. Real-time M2M traffic may include, for example, data from live monitoring of an event which does not trigger an alarm—such as building surveillance data, crop condition monitoring data, real-time billing transactions, and the like. Real-time M2M traffic is also classified as a GBR type, but is given the second highest priority, i.e., priority level “2”, relative to the other M2M traffic in the network 37. On the other hand, the delay-tolerant M2M traffic has been assigned a Non-Guaranteed Bit Rate (nGBR) type and given the lowest priority relative to the other M2M traffic in the network 37. Delay tolerant traffic (QCI value=12) has no immediate time constraints and may include, for example, metering data from a utility meter, fleet management tracking data, inventory management data from a supermarket, customer inputs to an automated data collection such as telemarketing or political surveys through robocalls, and the like. A higher scheduling priority gives the radio bearer a higher probability of obtaining network resources (e.g., RUs), and enables the associated M2M terminal to perform transmission or reception. In one embodiment, the M2M terminal with the highest priority is selected first for transmission.

It is observed from the above that because the priority levels in table 60 are relative to the M2M traffic only, the scheduler in the eNodeB 39 can dedicate the QCI values (and associated priority levels) from the table 33 to the UE traffic only. The disjoint sets in FIGS. 2 and 5 thus remove the competition between M2M terminals and UEs for the network resources because of the absence of having the same QCI value assigned to two different entities—an M2M terminal and a UE.

In one embodiment, for every cell (for which the eNodeB 39 is responsible for providing radio coverage) in every TTI, the scheduler in the eNodeB 39 (e.g., the scheduler 70 in FIG. 6) determines the UEs and M2M terminals that are to be assigned radio resources (i.e., RUs). In one embodiment, the hybrid scheduler in the eNodeB 39 performs the following (in the uplink and/or downlink) to allocate RUs to UEs and M2M terminals: (i) The scheduler may allocate RUs for M2M bearers using RUs from the first set only (as shown at blocks 50, 52 in FIG. 4). In one embodiment, the scheduler may allocate RUs for M2M bearers according to the M2M-specific QCI values in the table 60 only (as indicated at block 54 in FIG. 4). As mentioned before, the scheduler may select RUs only from the first set (at block 50 in FIG. 4) and continue allocating RUs to eligible M2M terminals until the number of allocated RUs is equal to “pR” (as given in equation (3) above) or all scheduling requests (received by the network entity 39 from the M2M terminals in the network 37) are fulfilled, whichever occurs first. (ii) The scheduler may then determine the remaining RUs (from all the available RUs) to be scheduled in this scheduling window. The remaining RUs may include any RU from the first set that remains unallocated in the previous step (i), and also all of the RUs that comprise the second set (of (1−p) % of total RUs as given at block 50 in FIG. 4). It is observed here that allocated RUs in the previous step (i) can be less than “pR” if the M2M traffic is very low. (iii) The scheduler may allocate only these remaining RUs for H2H/H2M bearers (to be assigned to one or more eligible UEs as indicated at block 56 in FIG. 4). In one embodiment, the scheduler may select one or more of these remaining RUs (for allocation to eligible UEs) according to the QCI values only from the existing QCIs in table 33 in FIG. 2 (as shown at block 58 in FIG. 4) Thus, the M2M traffic and the UE traffic are assigned QCI values from the two disjoint sets of QCI values—the table 60 in FIG. 5 and the table 33 in FIG. 2, respectively.

In particular embodiments, the scheduler in the eNodeB 39 (e.g., the hybrid scheduler 70 in FIG. 6) may allocate resources for GBR bearers first and then use round-robin scheduling for nGBR bearers—for both the M2M traffic and the UE traffic. In one embodiment, in case of resource allocation to nGBR bearers, the scheduler may select those nGBR bearers which have not been scheduled for the largest time since the last scheduling grant, so as to guarantee fairness among UEs (or M2M terminals) with nGBR bearers.

FIG. 6 depicts a block diagram of an exemplary network entity (e.g., the network entity 39 in FIG. 3) according to one embodiment of the present disclosure. As mentioned earlier, the network entity 39 may be an eNodeB (or eNB) or a similar wireless access node (or base station). The eNodeB 39 may be configured to perform hybrid scheduling (in the uplink and the downlink) as per the teachings of particular embodiments of the present disclosure. For example, in one embodiment, the eNodeB 39 may perform at least the actions at blocks 52, 54, 56, and 58 in the flowchart 44 in FIG. 4. In another embodiment, the eNodeB 39 may be configured to perform the division of RUs at blocks 48, 50 in FIG. 4 as well. The eNB 39 may include a baseband processor 62 to provide radio interface with the wireless terminals 12-13, 15-16 (in the carrier network 37 in FIG. 3) via eNB's Radio Frequency (RF) transceiver unit 64 coupled to the eNB's antenna unit 40. The transceiver unit 64 may include RF transmitter 65 and RF receiver 66 units coupled to the antenna unit 40 as shown. In one embodiment, the processor 62 may receive transmissions (e.g., scheduling requests in the UL) from the wireless terminals 12-13 and 15-16 via the combination of the antenna unit 40 and the receiver 66, whereas eNB's transmissions (e.g., UL scheduling instructions) to these wireless terminals may be carried out via the combination of the antenna unit 40 and the transmitter 65.

The processor 62 may be configured (in hardware and/or software) to perform the hybrid scheduling (using M2M-specific and UE-specific disjoint sets of RUs and QCIs) as per the teachings of the present disclosure so as to reduce competition between M2M terminals and UEs for the network's radio resources, thereby improving UE users' QoE. In one embodiment, the processor 62 may be configured (in hardware, via software, or both) to implement M2M-specific and UE-specific aspects of the hybrid scheduling methodology of the present disclosure. For example, when existing hardware architecture of the processor 62 cannot be modified, the functionality desired of the processor 62 may be obtained through suitable programming of the processor 62. The execution of the program code (by the processor 62) may cause the processor to perform as needed to support the hybrid scheduling solution as per the teachings of the present disclosure. Thus, although the processor 62 may be referred to as “performing,” “accomplishing,” or “carrying out” for similar such other terms) a function or process or method step, such performance may be technically accomplished in hardware and/or software as desired. In that regard, the processor 62 may include a processing unit 68 coupled to a hybrid scheduler 70 to enable the processor 62 to perform relevant steps discussed earlier with reference to FIG. 4. The processing unit 68 and the scheduler 70 may be coupled to a memory 72. In one embodiment, the memory 72 may store relevant program code for execution by the processing unit 68 and the scheduler 70 to enable the baseband processor 62 to carry out various steps of the hybrid scheduling methodology illustrated in FIG. 4. In certain embodiments, the memory 72 may represent portions of the internal memories of the processing unit 68 and/or the scheduler 70. In one embodiment, the memory 72 may store an M2M-specific set of QCI values (e.g., the QCI values in the table 60 in FIG. 5) and a UE-specific set of QCI values (e.g., the QCI values in the table 33 in FIG. 2), and make these values available to the scheduler 70 during scheduling of radio resources (e.g., in the uplink) to M2M terminals 12-13 and UEs 15-16. The scheduler 70 may then use appropriate QCI values during allocation of RUs to M2M terminals and UEs as discussed earlier with reference to blocks 52, 54, 56, and 58 in FIG. 4.

In one embodiment, the hybrid scheduler 70 may consist of two components—(i) an M2M scheduler 74 for allocating RUs to M2M terminals only (e.g., M2M terminals 12-13 in FIG. 3) according to the equation (3) above, and (ii) a UE scheduler 75 for allocating RUs to UEs only (e.g., UEs 15-16 in FIG. 3) according to the equation (4) above. Each component can be considered as a separate scheduler with its own optimization criteria and scheduling policy (in uplink and downlink). A primary difference, however, between the M2M scheduler component 74 and the UE scheduler component 75 in the embodiment of FIG. 6 is the limit on the available RUs each of these components is restricted to (as mathematically represented by equations (3) and (4) discussed earlier). In one embodiment, the M2M-specific scheduler 74 may perform the RU allocation (for M2M traffic) and QCI assignment steps illustrated at blocks 52 and 54 in FIG. 4, and the UE-specific scheduler 75 may perform the RU allocation (for UE traffic including H2H/H2M communications) and QCI assignment steps illustrated at blocks 56 and 58 in FIG. 4. In one embodiment, as mentioned earlier, the scheduler 70 may be configured to perform the division of RUs (at block 48 in FIG. 4) prior to commencement of any allocation by the component schedulers 74-75. The scheduler 70 may receive a value of “p” (in equations (3) and (4)) from the processing unit 68 (which may be configured to determine and store such value in the memory 72), or may itself be programmed (e.g., by the network operator) to compute different values of “p” (e.g., based on network traffic, or the number of M2M terminals and UEs to be scheduled in the UL/DL, etc.).

It is noted here that the two separate components 74-75 are shown for ease of explanation only. It does not necessarily imply physical division of the scheduler 70 into such distinct components 74-75. Rather, the depiction of two separate components 74-75 relates more to functional distinctions between these two components. In one embodiment, the scheduler 70 may remain a single, undivided entity and yet perform the distinct functions associated with these two components 74-75.

The processing unit 68 may be in communication with the memory 72 to process and store relevant information for the cell (e.g., identities of UEs or M2M terminals operating within the cell, scheduling requests or channel condition reports received from these wireless devices, etc.). The scheduler 70 may be part of the eNB's 39 processor 62 and may provide the Uplink (UL) and Downlink (DL) scheduling decisions for the wireless devices 12-13 and 15-16 based on a number of factors such as, for example, QoS (Quality of Service) parameters, device buffer status, UL and DL channel condition related information received from devices 12-13 and 15-16, device capabilities, etc. As mentioned before, in the embodiment of FIG. 6, the scheduler 70 may include the functionalities of the M2M-specific scheduler 74 and the UE-specific scheduler 75. The scheduler 70 (and its components 74-75) may have the same data structure as a typical scheduler in an eNB in an LTE system. The processor 62 may also provide additional baseband signal processing (e.g., mobile/wireless device registration, channel signal information transmission, radio resource management, etc.) as required. The processing unit 68 may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. The processor 62 may employ distributed processing in certain embodiments.

Hence, various steps of the hybrid scheduling methodology discussed earlier with reference to the exemplary FIGS. 3-5 may be implemented in UL/DL using the hybrid scheduler 70 in combination with the processing unit 68, the RF transceiver unit 64, the antenna unit 40, and the memory 72 (which, in one embodiment, may be part of the internal memory of the processing unit 68). In one embodiment, the program code necessary to configure the scheduler 70 and the processing unit 68 to carry out various method steps in FIG. 4 may reside in the shared memory 72 or may be stored in the internal memories (not shown) of these units. Upon execution of the relevant portion of the program code, each of these units (i.e., the scheduler 70 and the processing unit 68) may perform corresponding tasks attributed to them as per the teachings of the present disclosure (e.g., in one embodiment, the processing unit 68 performing the computation of a value for parameter “p” and dividing the RUs into two disjoint sets, whereas the scheduler 70 performing allocation of RUs as per equations (3) and (4), while assigning appropriate QCI values during allocations). It is noted, however, that other arrangements to implement the hybrid scheduling methodology illustrated in the exemplary embodiment of FIG. 4 may be devised as well. For example, in one embodiment, when the network entity 39 is a BSC, the functionality of the hybrid scheduler 70 may be implemented in such a BSC or a gateway/control node (not shown).

Some or all of the functionalities described above (e.g., division of RUs, allocation of M2M-specific and UE-specific RUs, assignment of M2M-specific and UE-specific QCI values, etc.) as being provided by an eNodeB or another network entity having similar functionality (such as a wireless access node/point, a mobile base station, a base station controller, and/or any other type of mobile communications node) may be provided by the processor 62 executing instructions stored on a computer-readable data storage medium, such as the memory 72 shown in FIG. 6.

The eNB 39 may further include a timing and control unit 78 and a core network interface unit 80 as illustrated in FIG. 6. The control unit 78 may monitor operations of the processor 62 and the network interface unit 80, and may provide appropriate timing and control signals to these units. The interface unit 80 may provide a bi-directional interface for the eNB 39 to communicate with its core network (e.g., the core network 42 in the embodiment of FIG. 3) to facilitate administrative and call/data-management functions for mobile subscribers and M2M terminals operating in the corresponding carrier network (e.g., the carrier network 37 in FIG. 3) through the eNB 39.

Alternative embodiments of the base station 39 may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features and elements. Some or all aspects of the hybrid scheduling methodology provided herein may be implemented in a computer program, software, or firmware incorporated in a computer-readable storage medium (e.g., the memory 72 in FIG. 6) for execution by a general purpose computer or a processor (e.g., the processing unit 68 in FIG. 6). Examples of computer-readable storage media include a Read Only Memory (ROM), a Random Access Memory (RAM), a digital register, a cache memory, semiconductor memory devices, magnetic media such as internal hard disks, magnetic tapes and removable disks, magneto-optical media, and optical media such as CD-ROM disks and Digital Versatile Disks (DVDs). In certain embodiments, the memory 72 may employ distributed data storage with/without redundancy.

The foregoing describes an M2M-aware time domain hybrid scheduler (and corresponding hybrid scheduling methodology) for LTE that differentiates between the M2M and UE traffic in the uplink and downlink. Prior to allocation of radio resources to UEs and M2M terminals, the available bandwidth (i.e., RUs available over a given scheduling interval) is divided into two disjoint sets—a UE-specific set (dedicated for H2H/H2M users (i.e., operators of UEs)) and an M2M-specific set (dedicated for M2M terminals). The hybrid scheduler allocates radio resources to M2M terminals from the M2M-specific set only. Any unallocated radio resource from the M2M-specific set and the radio resources assigned to the UE-specific set are then allocated to the UEs (of H2H/H2M users). Furthermore, the present disclosure also proposes new M2M-specific QCIs to facilitate end-to-end QoS for M2M traffic without impacting UE users' QoE. The new M2M-specific QCIs are for classifying M2M traffic only—i.e., these new QCIs are disjoint from the existing QCI values (which are now used to classify the UE traffic only). The new M2M-specific QCIs separate M2M traffic classification from UE traffic classification so as not to impact UE human users' QoE from M2M terminals competing for the network resources at the same QCI priority. The combination of bandwidth division and new M2M-specific QCI values allows network operators to accommodate a large number of M2M terminals in their networks without any significant investment in new radio equipment.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method in a mobile communication network for scheduling radio resources among a plurality of Machine-to-Machine (M2M) terminals being utilized for M2M communication and a plurality of User Equipments (UEs) being utilized for UE-based communication, wherein the M2M terminals and the UEs are in wireless communication with a network entity that allocates radio Resource Units (RUs) to the UEs and the M2M terminals in the mobile communication network, the method comprising:
prior to allocation of any RU by the network entity over a pre-defined scheduling interval, dividing all RUs that are available for allocation during the pre-defined scheduling interval into a first set of RUs dedicated to M2M terminals and a second set of RUs dedicated to UEs, wherein the first and the second sets are disjoint sets;
the network entity allocating RUs only from the first set to one or more M2M terminals; and
the network entity allocating only remaining RUs to one or more UEs, wherein the remaining RUs are selected from the following:
all unallocated RUs from the first set, and
all RUs from the second set.

2. The method of claim 1, wherein:
allocating RUs only from the first set includes allocating only first set-specific RUs to M2M bearers according to a first set of Quality of Service Class Identifier (QCI) values defined exclusively for classifying M2M traffic; and
allocating the remaining RUs to the UEs includes allocating the remaining RUs to UE-specific bearers according to a second set of QCI values configured for classifying UE traffic, wherein the first and the second sets of QCI values are disjoint sets.

3. The method of claim 2, wherein at least one QCI value in the first set of QCI values has a Guaranteed Bit Rate (GBR) priority level associated therewith.

4. The method of claim 1, wherein the network entity is one of the following:
a Radio Base Station (RBS);
a Base Station Controller (BSC);
an evolved Node B (eNodeB); and
a mobile communication node comprising a scheduler.

5. The method of claim 1, wherein each RU in the first and the second sets equals two Resource Blocks (RBs) over the pre-defined scheduling interval.

6. The method of claim 1, wherein the p defined scheduling interval is a Transmission Time Interval (TTI) of 1 ms duration.

7. The method of claim 1, wherein dividing all RUs includes dividing the RUs into the first and second sets of RUs based at least on the number of M2M terminals and the number of UEs for which radio resources are to be allocated during the pre-defined scheduling interval.

8. The method of claim 1, wherein dividing all RUs comprises:
assigning p % of all RUs that are available for allocation over the pre-defined scheduling interval to the first set of RUs; and
assigning (1−p) % of all RUs that are available for allocation over the pre-defined scheduling interval to the second set of RUs,
wherein the value of “p” is determined prior to the division of the RUs into the first and the second sets.

9. The method of claim 8, further comprising:
dynamically adjusting the value of “p” to adapt to M2M traffic and UE traffic in the mobile communication network.

10. The method of claim 1, further comprising:
receiving by the network entity, scheduling requests for radio resources from a number of the M2M terminals and a number of the UEs,
and wherein the network entity allocating RUs only from the first set includes:
the network entity allocating RUs only from the first set to the one or more M2M terminals requesting radio resources until all scheduling requests from the one or more M2M terminals have been fulfilled or until all RUs in the first set have been allocated, whichever occurs first.

11. A method for scheduling radio resources among a plurality of User Equipments (UEs) and a plurality of Machine-to-Machine (M2M) terminals using a network entity that utilizes Quality of Service Class Identifier (QCI) values in determining allocation of radio Resource Units (RUs) to the UEs and the M2M terminals, the method comprising:
defining a first set of QCI values only for M2M traffic from/to the M2M terminals, wherein the first set of QCI values is disjoint from a second set of QCI values to be used for communication traffic from/to the UEs.

12. The method of claim 11, wherein at least one QCI value in the first set has a Guaranteed Bit Rate (GBR) priority level associated therewith.

13. The method of claim 11, the method further comprising:
the network entity allocating RUs to the M2M terminals by using one or more QCI values only from the first set; and
the network entity allocating RUs to the UEs by using one or more QCI values only from the second set.

14. The method of claim 11, the method further comprising:
defining a first set of RUs containing p % of all RUs that are available for allocation over a pre-defined scheduling interval;
further defining a second set of RUs containing (1−p) % of all RUs that are available for allocation over the pre-defined scheduling interval, wherein the first and the second sets of RUs are disjoint sets, and wherein the value of “p” is determined before the first and the second sets are defined and is dynamically adjustable;
the network entity allocating RUs only from the first set of RUs to one or more M2M terminals, using one or more QCI values only from the first set; and
the network entity allocating to one or more UEs only those RUs that are selected from the group consisting of: all unallocated RUs from the first set of RUs and all RUs from the second set of RUs, using one or more QCI values only from the second set.

15. A method for scheduling radio resources among a plurality of User Equipments (UEs) and a plurality of Machine-to-Machine (M2M) terminals that are in wireless communication with a network entity in a mobile communication network, wherein the network entity allocates radio Resource Units (RUs) to the UEs and the M2M terminals, the method comprises performing the following using the network entity:
selecting RUs to be allocated to one or more M2M terminals only from a first set of RUs containing p % of all RUs that are available for allocation over a pre-defined scheduling interval;
allocating the selected RUs to the one or more M2M terminals;
selecting remaining RUs to be allocated to one or more UEs from the following:
all RUs from the first set of RUs that are not allocated to the one or more M2M terminals, and
a second set of RUs containing (1−p) % of all RUs that are available for allocation over the pre-defined scheduling interval, wherein the first and the second sets of RUs are disjoint sets, and wherein the value of “p” is determined before the available RUs are divided into the first and the second sets; and
allocating the selected remaining RUs to the one or more UEs.

16. The method of claim 15, wherein:
allocating the selected RUs to the one or more M2M terminals includes allocating the selected RUs to the one or more M2M terminals according to Quality of Service Class Identifier (QCI) values only from a first set of QCI values defined exclusively for classifying M2M traffic from/to the M2M terminals; and
allocating the selected remaining RUs to the one or more UEs includes allocating the selected remaining RUs to the one or more UEs according to QCI values only from a second set of QCI values configured for classifying communication traffic from/to the UEs,
wherein the first set of QCI values is disjoint from the second set of QCI values.

17. The method of claim 15, wherein the value of “p” is variable.

18. The method of claim 15, wherein each RU in the first and the second sets of RUs equals two Resource Blocks (RBs) over the pre-defined scheduling interval, and wherein the pre-defined scheduling interval is a Transmission Time Interval (TTI) of 1 ms duration.

19. The method of claim 15, wherein the network entity is one of following:
a Radio Base Station (RBS);
a Base Station Controller (BSC);
an evolved Node B (eNodeB); and
a mobile communication node comprising a scheduler.

20. A mobile communication node configured to schedule radio resources among a plurality of User Equipments (UEs) and a plurality of Machine-to-Machine (M2M) terminals that are in wireless communication with the mobile communication node in a mobile communication network, wherein the mobile communication node comprises:
a transceiver configured to transmit and receive wireless signals to/from the UEs and the M2M terminals; and
a scheduler coupled to the transceiver and configured to send radio resource scheduling information to the UEs and the M2M terminals via the transceiver, wherein the scheduler is configured to perform the following:
allocate up to p % of all radio Resource Units (RUs) that are available for allocation over a pre-defined scheduling interval only to one or more M2M terminals, and
allocate to one or more UEs only those RUs that are selected from the group consisting of: any RU that remains unallocated to the M2M terminals, and the remaining (1−p) % of the total RUs available for allocation over the pre-defined scheduling interval,
wherein the value of “p” is determined prior to allocation of any RU over the pre-defined scheduling interval.

21. The mobile communication node of claim 20, further comprising:
a memory configured to store a first set of Quality of Service Class Identifier (QCI) values defined for classifying only M2M traffic from/to the M2M terminals, and a second set of QCI values configured for classifying UE traffic from/to the UEs, wherein the first and the second sets are disjoint sets, and
wherein the scheduler is coupled to the memory and is further configured to perform the following:
allocate RUs to the M2M terminals using one or more QCI values only from the first set, and
allocate RUs to the UEs using one or more QCI values only from the second set.

22. The mobile communication node of claim 20, wherein each RU equals two Resource Blocks (RBs) over the pre-defined scheduling interval, and wherein the pre-defined scheduling interval is a Transmission Time Interval (TTI) of 1 ms duration.

23. The mobile communication node of claim 20, wherein the value of “p” is variable, and wherein the mobile communication node further comprises a processor coupled to the scheduler and configured to provide the value of “p” to the scheduler for the pre-defined scheduling interval based on M2M traffic and UE traffic in the mobile communication network.

24. A mobile communication node configured to schedule radio resources among a plurality of User Equipments (UEs) and a plurality of Machine-to-Machine (M2M) terminals that are in wireless communication with the mobile communication node in a mobile communication network, wherein the mobile communication node is further configured to perform the following:
select radio Resource Units (RUs) to be allocated to one or more M2M terminals only from a first set of RUs containing p % of all RUs that are available for allocation during a pre-defined scheduling interval;
allocate the selected RUs to the one or more M2M terminals using one or more Quality of Service Class Identifier (QCI) values only from an M2M-specific set of QCI values, wherein the M2M-specific set contains QCI values defined only for M2M traffic from/to the M2M terminals, and wherein the M2M-specific set of QCI values is disjoint from a UE-specific set of QCI values to be used for UE traffic from/to the UEs; and
using one or more QCI values only from the UE-specific set, allocate to one or more UEs only those RUs that are selected from the following:
all RUs from the first set that are not allocated to the one or more M2M terminals, and
all RUs from a second set of RUs containing (1−p) % of all RUs that are available for allocation during the pre-defined scheduling interval, wherein the first and the second sets are disjoint sets, and wherein the value of “p” is determined before the available RUs are divided into the first and the second sets.
